(19) United States
(12) Patent Application Publication
(10) Pub. No.: US 2008/0048539 A1
(43) Pub. Date: Feb. 28, 2008

(54) REFRIGERATOR CAPABLE OF BEING OPENED FROM OPPOSITE SIDES

(76) Inventors: Jacco Van BEEK, Breda (NL); Wilco WESSELS, Ulvenhout (NL)

Correspondence Address: HARNESS, DICKEY & PIERCE, P.L.C., P.O. BOX 828, BLOOMFIELD HILLS, MI, 48303, US

(21) Appl. No.: 11/843,947

(22) Filed: Aug. 23, 2007

Related U.S. Application Data
(60) Provisional application No. 60/840,058, filed on Aug. 24, 2006.

(51) Int. Cl. E05D 15/48

(52) U.S. Cl. 312/405

(57) ABSTRACT

A refrigerator includes a cabinet and a door rotatably interconnected to the cabinet for rotation about an axis. A hinge pin interchangeably interconnects one of a left hand side of the door and a right hand side of the door with the cabinet. A lock pin interchangeably interconnects the other of the left hand side and the right hand side of the door with the cabinet. A lock pin control member secures the lock pin to the door. The lock pin control member is movable between upper and lower positions to move the lock pin between locked and unlocked positions.

### CROSS-REFERENCE TO RELATED APPLICATIONS

This application claims priority to U.S. Provisional Patent Application No. 60/840,058 filed 24 Aug. 2006, which application is herein expressly incorporated by reference.

### FIELD

The present teachings relate generally to refrigerators. More particularly, the present teachings relate a refrigerator that may be readily adapted to selectively open from a left side or a right side.

### BACKGROUND

The statements in this section merely provide background information related to the present disclosure and may not constitute prior art.

Commonly assigned U.S. Pat. No. 6,000,771 discloses a refrigerator with a swinging closure door capable of being opened from both left and right sides. In one application, the refrigerator of the '771 patent may be used within a motor vehicle. In such applications, the refrigerator of the '771 patent does not unnecessarily limit the usage of the remainder of the vehicle interior. In this regard, the kitchen of the vehicle may be designed for either a left hand opening or a right hand opening refrigerator door. U.S. Pat. No. 6,000,771 is hereby incorporated by reference as if fully set forth herein.

While the refrigerator of U.S. Pat. No. 6,000,771 satisfactorily provides a refrigerator with a door that can be selectively opened from opposite sides, it remains desirable to provide continued advancement in the pertinent art.

### SUMMARY

In accordance with one particular aspect, the present teachings provide a refrigerator including a cabinet and a door rotatably interconnected to the cabinet for rotation about a hinge axis. A hinge pin interchangeably interconnects one of a left hand side of the door and a right hand side of the door with the cabinet at the hinge axis. A lock pin interchangeably interconnects the other of the left hand side and the right hand side of the door with the cabinet. The lock pin is operative to releasably lock the door relative to the cabinet. A lock pin control member secures the lock pin to the door. The lock pin control member is movable between upper and lower positions to move the lock pin between locked and unlocked positions.

In accordance with another particular aspect, the present teaching provides a refrigerator including a cabinet and a door rotatably interconnected to the cabinet for rotation about a hinge axis. A first pin interchangeably interconnects one of a left hand side of the door and a right hand side of the door with the cabinet. A second pin interchangeably interconnects the other of the left hand side and the right hand side of the door with the cabinet. First and second control members secure the first and second pins to the door, respectively. The first and second pins are interchangeable. The first pin defines a hinge pin elongated along the hinge axis. The second pin defines a lock pin for releasably locking the door in a closed position.

### DRAWINGS

The present teachings will become more fully understood from the detailed description, the appended claims and the following drawings.

FIG. 1 is a perspective view of a refrigerator in accordance with the present teachings.

FIG. 2 is a partially exploded perspective view of the refrigerator in accordance with the present teachings.

FIG. 3 is an enlarged front view of a portion of the refrigerator in accordance with the present teachings.

FIG. 4 is an enlarged rear view of a portion of the refrigerator in accordance with the present teachings.

FIG. 5 is a front perspective view of a portion of the refrigerator in accordance with the present teachings, a top portion of the door removed to illustrate the cooperative relationship of a lock pin with the remainder of the refrigerator, the lock pin shown operatively associated with a left side of the door.

FIG. 6 is another front perspective view of a portion of the refrigerator in accordance with the present teachings, the top portion of the door removed to illustrate the cooperative relationship of a hinge pin with the remainder of the refrigerator, the hinge pin shown operatively associated with a right side of the door.

FIG. 7 is a rear perspective view of a portion of the door of the refrigerator in accordance with the present teachings, the lock pin shown operatively associated with a left side of the door.

FIG. 8 is another rear perspective view of a portion of the door of the refrigerator in accordance with the present teachings, the hinge pin shown operatively associated with a right hand side of the door.

FIG. 9 is cross-sectional view of a portion of the refrigerator in accordance with the present teachings, the cross-sectional view taken through the hinge pin.

FIG. 10 is a perspective view of another refrigerator in accordance with the present teachings.

### DESCRIPTION OF VARIOUS ASPECTS

The following description is merely exemplary in nature and is not intended to limit the present disclosure, application, or uses. It should be understood that throughout the drawings, corresponding reference numerals indicate like or corresponding parts and features. The description and any specific examples, while indicating embodiments of the present disclosure, are intended for purposes of illustration only and are not intended to limit the scope of the present disclosure. Moreover, recitation of multiple embodiments having stated features is not intended to exclude other embodiments having additional features, or other embodiments incorporating different combinations of the stated features.

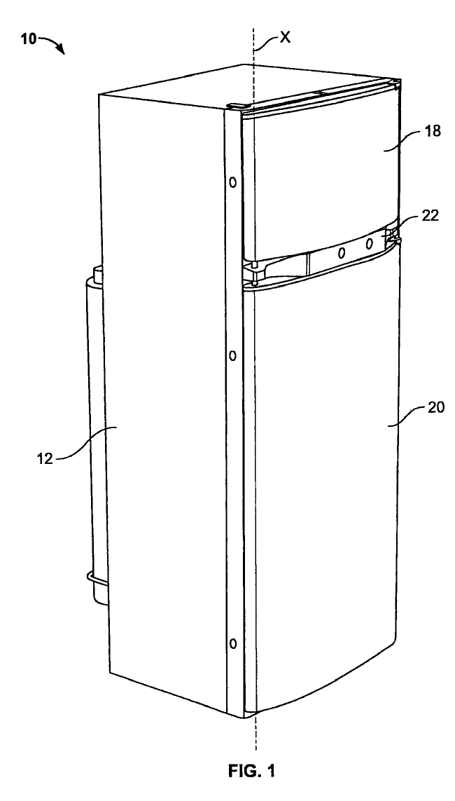

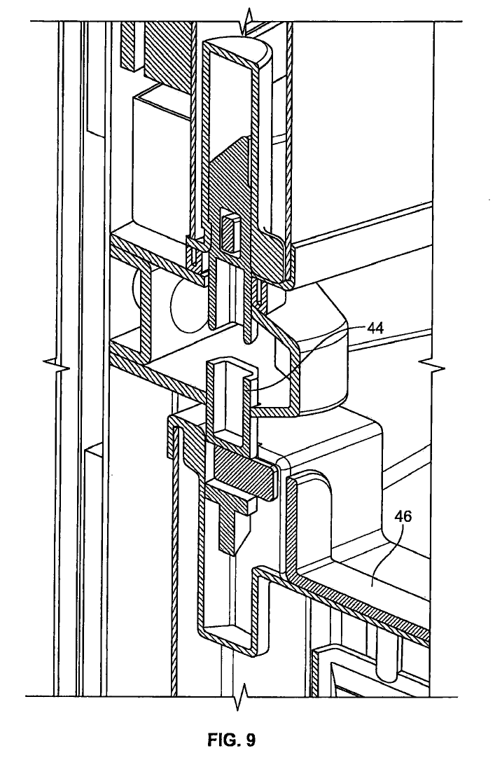

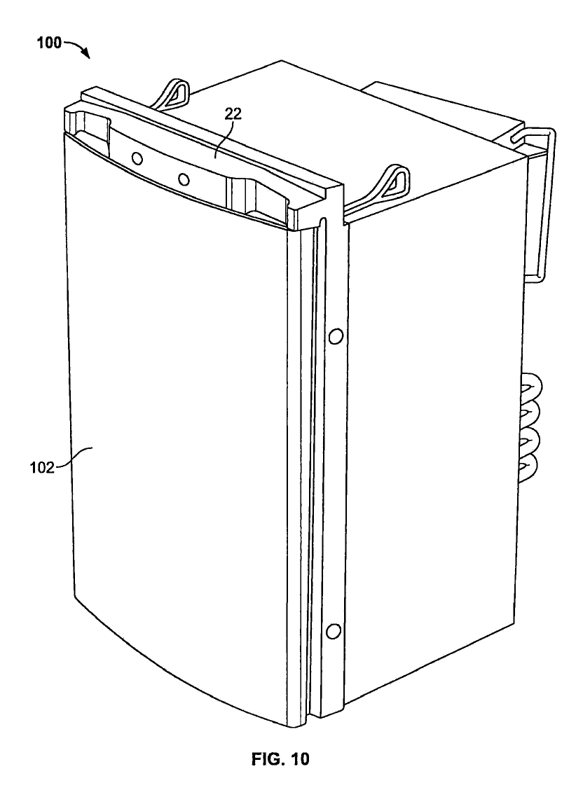

With general reference to FIGS. 1 through 9 of the drawings, a refrigerator in accordance with the present teachings is generally identified at reference character 10. The refrigerator 10 may be used for motor vehicle applications and other applications. It will become apparent to those skilled in the art after reading the remaining detailed description that various teachings of the present invention have application beyond such an exemplary use.

Various terms of reference may be used below. For example, opposing lateral sides of the refrigerator 10 may be described as left (or left hand) and right (or right hand) sides. It will be understood that such terminology is used relative to a front side of the refrigerator 10. Such terms are intended to be illustrative of a particular embodiment and not necessary limiting of the present teachings.

The refrigerator 10 may generally include a cabinet 12 defining one or more storage compartments. The storage compartments may include an upper compartment 14 and a lower compartment 16. The upper compartment 14 may be a freezer compartment adapted to be maintained at a temperature below freezing and the lower compartment 16 may be a refrigeration compartment adapted to be maintained at a cooling temperature above freezing. As will be appreciated more fully below, the present teachings are not limited to any particular refrigerator orientation.

The refrigerator 10 may include a door for selectively closing and providing access to each of the storage compartments 14 and 16. In the embodiment illustrated, the refrigerator 10 may include an upper door 18 and a lower door 20. In a manner to be addressed below, the doors 18 and 20 may be mounted to the cabinet 12 between open and closed positions about a vertically extending pivot axis X (see FIG. 1). The doors 18 and 20 may be particularly adapted so that the pivot axis X may be selectively and readily located at a left hand side or right hand side of the respective door.

The refrigerator 10 may generally include a cabinet extension 22. The cabinet extension 22 may be positioned between the upper and lower doors 18 and 20 and may be secured to the cabinet 12. Attachment to the cabinet 12 may be accomplished with fasteners or in any other manner well known in the art. The cabinet extension 22 may carry certain control and/or display features for the refrigerator 10. For example, the cabinet extension 22 may carry temperature controls, temperature indicators, and the like.

The lower door 20 may include a cap or top portion 24 carried by the remainder of the door 20. The top portion 24 may be formed with the door 20 or may be a discrete component secured to the remainder of the door 20 in any well known manner. The top portion 24 may be injection molded of plastic or other suitable material.

The top portion 24 may be generally symmetrical about a midline Y of the door (see FIG. 4). In this regard, the top portion 24 may include a right hand recessed portion 30 and a left hand recessed portion 32. The right hand recessed portion 30 may be at least partially defined by a front face 34 of the top portion 24, and a right end 36 of the top portion 32. The right hand recessed portion 30 may be open in a rearward direction. Similarly, the left hand recessed portion 32 may be at least partially defined by the front face 34 of the top portion 24, a left end 38 of the top portion 32, and may be open in a rearward direction.

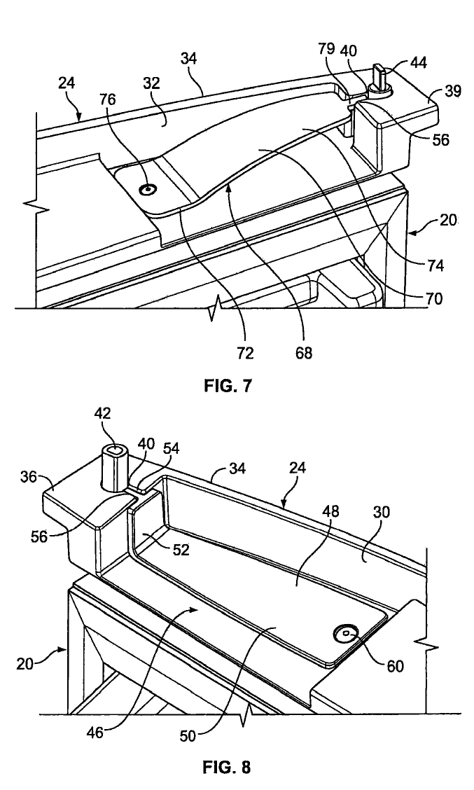

The right and left ends 36 and 38 of the top portion 32 may define generally cylindrical apertures 40 (see FIGS. 7 and 8, for example). The generally cylindrical apertures 40 may interchangeably receive one of a hinge pin 42 and a lock pin 44. For example, where it is desired to configure the refrigerator 10 to include a right hand side door pivot axis X, the cylindrical aperture 40 of the right end 36 of the top portion 32 will receive the hinge pin 42 and the cylindrical aperture 40 of the left end 38 will include the lock pin 44. Conversely, where it is desired to configure the refrigerator 10 to include a left hand side door pivot axis X, the cylindrical aperture 40 of the left end 38 of the top portion 32 will receive the hinge pin 42 and the cylindrical aperture 40 of the right end 36 will include the lock pin 44.

A first control member 46 may be used to interconnect the hinge pin 42 to the door 20. The first control member or hinge pin control member 46 may include a main body portion 48 having first and second legs 50 and 52 disposed in one of the recessed portions 30 and 32. The first leg 50 may be positioned proximate a lower surface of the respective recessed portion 30 or 32 and the second leg 52 may be positioned proximate the respective right or left end 36 or 38 of the top portion 32 of the door 20. A retaining portion 54 may extend from the second leg 52, pass through a slot 56 interconnecting the respective recessed portion 30 or 32 with the aperture 40, and engage an opening 58 defined by the hinge pin 42.

The first control member 46 may be fixedly secured to the top portion 32 of the door 20 with a fastener 60 or in with any other well known technique. The first control member 46 may additional incorporate a pair of integrally formed pins 59 (one of which is identified in FIG. 6). The pins 59 may engage apertures in the top portion 32 to prevent rotation of the first control member 46 relative to the door. In this manner, the hinge pin 42 may be fixed relative to the door 20.

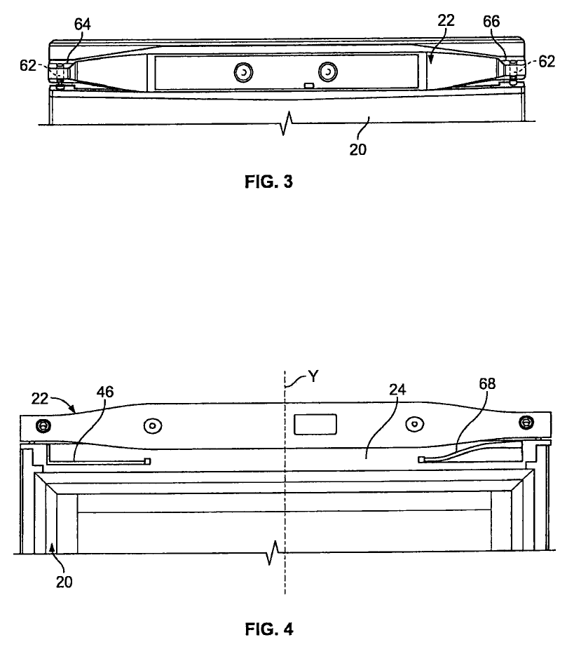

The cabinet extension 22 defines apertures 62 at laterally opposite left and right sides 64 and 66 (see FIG. 3). The apertures 62 may selectively receive one of the hinge pin 42 and lock pin 44. For example, where it is desired to configure the refrigerator 10 to include a right hand side door pivot axis X, the aperture 62 at the right side 66 of the cabinet extension 22 will receive the hinge pin 42. Conversely, where it is desired to configure the refrigerator 10 to include a left hand side door pivot axis X, the aperture 62 of the left side 64 of the cabinet extension 22 will receive the hinge pin 42.

A second control member or lock pin control member 68 may be used to interconnect the lock pin 44 to the door 20. The lock pin 44 may be interconnected to the door 20 for movement in a generally vertical direction. The second control member 68 may include a main body portion 70 having a mounting portion 72 and a moveable portion 74. In certain applications, the second control member 68 may be constructed of a flexible plastic material and may be elastically deformable such that the end opposite the mounting portion 72 may be repeated moved relative to the mounting portion 72.

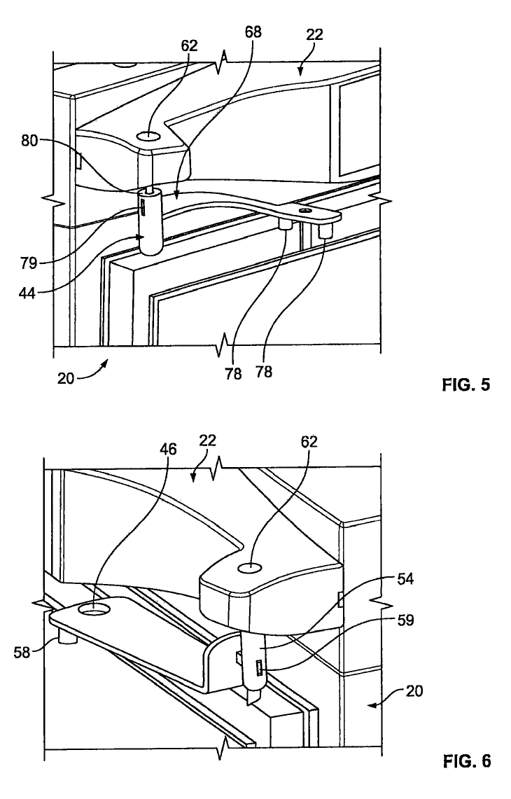

The mounting portion 72 may secured to the top portion 32 of the door 20 with a fastener 76 or in with any other well known technique. As with the first control member 46, the second control member 68 may additional incorporate a pair of integrally formed pins 78 (shown in FIG. 5). The pins 78 may engage apertures in the top portion 32 to prevent rotation of the second control member 68 relative to the door 20.

A retaining portion 79 may extend from the free end of the moveable portion 74. The retaining portion 79 may pass through the slot 56 interconnecting the respective recessed portion 30 or 32 with the aperture 40 and engage an opening 80 defined by the lock pin 44. The second control member 68 may function to normally bias the lock pin 44 to an upper position engaging one of the apertures 62 of the cabinet extension 22. For example, with a right hand door pivot axis X, the aperture 62 at the left side 64 of the cabinet extension 22 will receive the lock pin 44. Conversely, with a left hand door pivot axis X, the aperture 62 at the right side 66 of the cabinet extension 22 will receive the lock pin 44. In this manner, the lock member 44 will function to retain the door 20 in its closed position.

The apertures 62 that selectively receive the hinge and lock pins 42 and 44 have been described herein as being defined by the cabinet extension 22. Alternate structure for engaging the hinge and lock pins 42 and 44 may also be used within the scope of the present teachings. In this regard, the hinge and lock pins 42 and 44 may engage apertures or other retaining structure carried by a simple bracket extending from the cabinet 12.

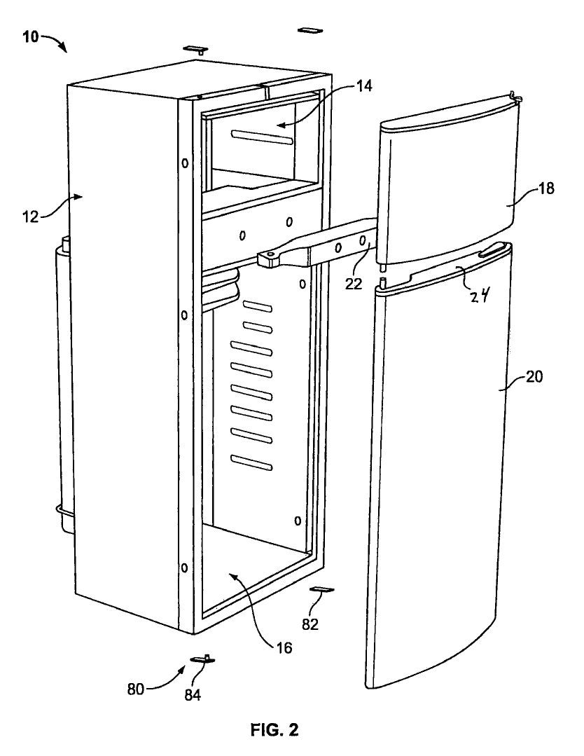

A lower end of the door 20 is supported by a pair of brackets 80 and 82. A first bracket 80 is secured to the cabinet 12 and carries a hinge pin 84. The hinge pin 84 rotatably engages a lower aperture (not particularly shown) of the door 20. As shown in the exploded view of FIG. 2, the first bracket 80 is carried by a left side of the refrigerator 10 as the door 20 will be secured to the cabinet 12 for rotation about a left hand side pivot axis X. In such an arrangement, the second bracket 82 is mounted proximate the right side of the cabinet 12 and functions to support the door 20 when the door is in its closed position. When it is desired to change from a left hand side pivot axis to a right hand side pivot axis, the second bracket 82 may carry the hinge pin and the first bracket 80 may support the door 20 in the closed position. By interchangeably moving the hinge pin 84 between the brackets 80 and 82 quick and easy changing of the side of the axis X is further enabled.

In use, the moveable portion 74 of the second control member 68 may be downwardly deflected from the position shown in the drawings through a simple manual application of force. Such downward deflection in turn may function to downwardly translate the lock pin 44 and thereby disengage the lock pin 44 from the corresponding aperture 62. At this point, the door 20 is free to rotate about its pivot axis X.

The upper end of the lock pin 44 may be provided with a lead-in surface. For example, the upper end of the lock pin 44 may be angled. The angle of the upper end may function to downwardly displace the lock pin 44 against the normal bias of the second control member 68 upon rotation of the door 20 to its closed position. In this manner, the user need not manually displace the moveable portion 74 of the second control member 68 before rotating the door 20 to its closed position. Contact between the cabinet extension 22 and the lock pin 44 will automatically serve to downwardly displace the lock pin 44 until the lock pin 44 is aligned with the respective aperture 62. At such point, the normal bias of the second control member 68 will translate the lock pin 44 upward and thereby lock the door 22 in its closed position.

The present teachings have heretofore been described in connection with a pair of control members 46 and 68 carried by the lower door 20. It will be understood that the upper door 18 may similarly be provided with first and second control members 46 and 68. In such an arrangement, the first and second control members 46 and 68 may be carried at a lower end of the door 18 and cooperate with the cabinet extension 22. Alternatively, structure can be carried proximate an upper end of the upper door 18 to cooperate with the hinge and lock pins 44 and 46. Such alternate structure may include simple brackets with holes to receive the pins 44 and 46. As described here, the refrigerator 10 includes a hinge pin 42 and a lock pin 44. As illustrated throughout the drawings, a common component may alternatively function as both the hinge pin 42 and the lock pin 44. Explaining further, a common component may simply be used in one oriented to function as the hinge pin 42 and in another orientation to function as a lock pin 44. The common component may be a generally cylindrical structure. In certain applications, the ends may be distinct with a hinge end oriented upward when the component functions as the hinge pin 42 and a lock end oriented upward when the component functions as a lock pin 44. In other applications, the ends may be identical. In this regard, a common structure in a common orientation may be used as the lock pin 44 and the hinge pin 42. When functioning as the lock pin 44, the component is simply coupled to the door 20 for translation.

As described herein, the refrigerator 10 includes a hinge pin 42 and a lock pin 44. As illustrated throughout the drawings, a common component may alternatively function as both the hinge pin 42 and the lock pin 44. Explaining further, a common component may simply be used in one oriented to function as a hinge pin 42 and another orientation to function as a lock pin 44.

Turning to FIG. 10, another refrigerator constructed in accordance with the present teachings is illustrated and generally identified at reference character 100. As shown, the refrigerator 100 may include a single door 102. The refrigerator 100 includes a cabinet extension 22 substantially identical to the refrigerator 10. Similarly, the upper end of the door 102 carries first and second control members 46 and 68 which function in the manner discussed above for providing interchangeable lock and hinge sides of the refrigerator 100.

While specific examples have been described in the specification and illustrated in the drawings, it will be understood by those skilled in the art that various changes may be made and equivalence may be substituted for elements thereof without departing from the scope of the present teachings. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description.

What is claimed is:

1. A refrigerator comprising:
a cabinet;
a door rotatably interconnected to the cabinet for rotation about a hinge axis;
a hinge pin interchangeably interconnecting one of a left hand side of the door and a right hand side of the door with the cabinet at the hinge axis;
a lock pin interchangeably interconnecting the other of the left hand side and the right hand side of the door with the cabinet, the lock pin operative to releasably lock the door relative to the cabinet; and
a lock pin control member securing the lock pin to the door, the lock pin control member being movable between upper and lower positions to move the lock pin between locked and unlocked positions.

2. The refrigerator of claim 1, further comprising a hinge pin control member securing the hinge pin to the door.

3. The refrigerator of claim 1, wherein the lock pin control member is elastically deformable.

4. The refrigerator of claim 1, wherein the lock pin linearly translates between the locked and unlocked positions.

5. The refrigerator of claim 1, wherein a free end of the lock pin control member engages the lock pin.

6. The refrigerator of claim 2, wherein the hinge pin control member includes a retention member engaging the hinge pin.

7. The refrigerator of claim 1, wherein the door includes a top portion defining a pair of apertures for interchangeably receiving the lock and hinge pins.

8. The refrigerator of claim 1, wherein the refrigerator includes a cabinet extension, the cabinet extension extending forwardly from the cabinet and disposed proximate an upper end of the door, the cabinet extension defining a pair of apertures for selectively receiving the lock and hinge pins.

9. The refrigerator of claim 1, wherein the hinge pin and the lock pin are substantially identical.

10. The refrigerator of claim 1, wherein the lock pin control member includes a portion for attachment to the door and a moveable portion interconnected to the lock pin such that movement of the moveable portion linearly translates the lock pin between the locked and unlocked positions.

11. A refrigerator comprising:
a cabinet;
a door rotatably interconnected to the cabinet for rotation about a hinge axis;
first and second pins, the first pin interchangeably interconnecting one of a left hand side of the door and a right hand side of the door with the cabinet, the second pin interchangeably interconnecting the other of the left hand side and the right hand side of the door with the cabinet; and
first and second control members securing the first and second pins to the door, respectively, the first and second pins being interchangeably, the first pin defining a hinge pin elongated along the hinge axis, the second pin defining a lock pin for releasably locking the door in a closed position.

12. The refrigerator of claim 11, wherein the first and second pins are substantially identical.

13. The refrigerator of claim 12, wherein the second pin is moveable between locked and unlocked positions.

14. The refrigerator of claim 13, wherein the second pin is linearly moveable between the locked and unlocked positions.

15. The refrigerator of claim 13, wherein the first control member is moveable between first and second positions to move the lock pin between the locked and unlocked positions in response to elastic deformation of the first control member.

16. The refrigerator of claim 11, wherein a free end of the second control member engages the second pin.

17. The refrigerator of claim 11, wherein the first control member includes a retention member engaging the hinge pin.

18. The refrigerator of claim 11, wherein the door includes a top portion defining a pair of operatives for interchangeably receiving the first and second pins.

19. The refrigerator of claim 11, wherein the refrigerator includes a cabinet extension extending forwardly from the cabinet and disposed proximate an upper end of the door, the cabinet extension defining a pair of apertures for selectively receiving the first and second pins.

20. The refrigerator of claim 12, wherein the first and second pins include a lock pin end and a hinge pin end, the first pin oriented with the lock pin end engaging the door, the second pin oriented with the hinge pin end engaging the door.
